(19) United States
(12) Patent Application Publication
(10) Pub. No.: US 2021/0197462 A1
(43) Pub. Date: Jul. 1, 2021

(54) TOPOGRAPHIC BUILD PLATE FOR ADDITIVE MANUFACTURING SYSTEM

(71) Applicant: HEWLETT-PACKARD DEVELOPMENT COMPANY, L.P., Spring, TX (US)

(72) Inventors: Alan BROCHIER, Porto Alegre, Rio Grande do Sul (BR); Gustavo CALLEGARI, Porto Alegre, Rio Grande do Sul (BR); Lucio POLESE COSSIO, Porto Alegre, Rio Grande do Sul (BR); Fernanda Maira GALLINA, Porto Alegre, Rio Grande do Sul (BR); Renato OLIVEIRA DA SILVA, Porto Alegre, Rio Grande do Sul (BR)

(73) Assignee: HEWLETT-PACKARD DEVELOPMENT COMPANY, L.P., Houston, TX (US)

(21) Appl. No.: 16/074,996

(22) PCT Filed: Jan. 31, 2017
(86) PCT No.: PCT/US2017/015751

§ 371 Date: Aug. 2, 2018

(51) Int. Cl. B29C 64/245; B29C 64/232; B29C 64/393; B29C 64/40; B33Y 10/00; B33Y 30/00; B33Y 50/02

(52) U.S. Cl. CPC B29C 64/245; B29C 64/232; B29C 64/393; B33Y 50/02; B33Y 10/00; B33Y 30/00; B29C 64/40

(57) ABSTRACT

In one example, a topographic build plate for an additive manufacturing system. The build plate is to support a 3D object fabricated layer-by-layer, and is divided into plural blocks each having a build surface. In-between fabrication of layers of the object, a first one of the blocks is offset in a Z-direction from a second one of the blocks to position the build surfaces of the first and second blocks at different Z-direction locations to replace at least a portion of a support structure of the 3D object.

### BACKGROUND

Additive manufacturing (AM) is a popular technique for fabricating prototype and/or production three-dimensional (3D) objects. A 3D object is fabricated from a build material by an additive manufacturing system in a layer-by-layer manner. The pattern for each layer of the object is determined according to a corresponding computer model of the 3D object. A cross-sectional “slice” of the model, having a thickness corresponding to the thickness of a layer of the object, defines the pattern for that layer. A base portion of the 3D object, as it is oriented for fabrication, has a footprint which is in contact with a build plate of the system; the slices of the model have the same orientation. As oriented, some 3D objects have “overhangs”—features of the 3D object which extend outside the footprint, and which are offset from the base and not in contact with the built plate. In some AM systems, at least one sacrificial support structure, which can extend from the overhang to the built plate, is formed during fabrication. The support structure, such as for example a pillar, supports the overhang to prevent damage to the 3D object and to enable the 3D object to stand in place during fabrication. After fabrication is complete, the support structure is removed and discarded.

### BRIEF DESCRIPTION OF THE DRAWINGS

FIG. 1 is a schematic representation of an additive manufacturing system having a topographic build plate in accordance with an example of the present disclosure.

FIG. 2 is a schematic representation of another additive manufacturing system having a topographic build plate in accordance with an example of the present disclosure.

FIG. 3 is a flowchart of a method of fabricating a 3D object usable with the additive manufacturing system of FIG. 1 or 2 in accordance with an example of the present disclosure.

FIG. 4 is a flowchart of another method of fabricating a 3D object usable with the additive manufacturing system of FIG. 1 or 2 in accordance with an example of the present disclosure.

FIG. 5 is a schematic representation of a controller usable with the additive manufacturing system of FIG. 1 or 2, in accordance with an example of the present disclosure.

FIG. 6 is a schematic representation of an example computer model of an example 3D object which can be fabricated by the additive manufacturing system of FIG. 1 or 2 using the model and having a reduced amount of support structure, in accordance with an example of the present disclosure.

FIGS. 7A through 7M are schematic representations of stages of the fabrication of the example 3D object of FIG. 6, in accordance with an example of the present disclosure.

### DETAILED DESCRIPTION

There are numerous types of layer-by-layer AM technologies and systems. One attribute that many such systems have in common is that the build plate on which the 3D object is fabricated moves along a vertical axis (downward, in systems where the object is fabricated beginning with the bottom layer) by the thickness of a layer after each layer is fabricated. Alternatively or in addition, in some systems the build engine or a component thereof moves along the vertical axis. As a result, every layer is formed at the same vertical position within the system. In many cases, the vertical position of the build engine during layer fabrication is also the same for each layer. The initial layer is fabricated on the build plate. Each subsequent layer is fabricated on the previous layer.

One type of AM system is a fused deposition modeling (FDM) system. An FDM system selectively extrudes from a nozzle, for a given layer, a filament of molten build material at the desired locations which correspond to the 3D object and its support structure. In some examples, the build material is a thermoplastic or a metal. The build material quickly hardens after extrusion to form the layer of the 3D object. In some examples, the object is fabricated beginning with its bottom layer, after which the build plate moves downward in preparation for fabricating the next layer.

Another type of AM system is a stereolithography (SLA, or SL) system. An SLA system fabricates a layer of a 3D object by focusing an ultraviolet laser on selected positions on a surface of a tank of a liquid build material such as a photopolymer resin. The laser solidifies the build material at the selected positions to form that layer of the part. The object may be fabricated beginning with its bottom layer, where the laser irradiates a resin layer at the top of the tank from above the tank, after which the build plate moves downward in preparation for the next layer. Alternatively, the object may be fabricated beginning with its top layer by exposing a resin layer at the bottom of the tank through an at least partially transparent bottom surface of the tank, after which the build plate to which the object is adhered moves upward in preparation for fabricating the next layer.

Another type of AM system is a selective laser sintering (SLS) system. An SLS system uses laser irradiation to sinter selected areas of a layer of a build material, which may be metal, plastic, ceramic, glass, or another material in powdered form, to harden and bond the particles to each other and to the previous layer. In some examples, the object is fabricated beginning with its bottom layer, after which the build plate moves downward in preparation for fabricating the next layer.

Yet another type of AM system is a powder and fusing agent (PFA) system. A PFA system uses a simpler and less expensive heat source to fuse the build material in each layer, rather than a laser. The build material may be of a light color, which may be white. In one example, the build material is a light-colored powder. A print engine controllably ejects drops of a liquid fusing agent onto the regions of powder which correspond generally to the location of the object cross-section within the corresponding digital slice. The print engine, in an example, uses inkjet printing technology. In various examples, the fusing agent is a dark colored liquid such as for example black pigmented printing liquid, a UV absorbent liquid or printing liquid, and/or other liquid(s). A heat source, such as for example one or more infrared fusing lamps, is then passed over the entire print zone. The regions of the powder on which the fusing agent have been deposited absorb sufficient radiated energy from the heat source to melt the powder in those regions, fusing that powder together and to the previous layer underneath. However, the regions of the powder on which the fusing agent have not been deposited do not absorb sufficient radiated energy to melt the powder. As a result, the portions of the layer on which no fusing agent was deposited remain in unfused powdered form. To fabricate the next layer of the object, another layer of powder is deposited on top of the layer which has just been processed, and the printing and fusing processes are repeated for the next digital slice. This process continues until the object has been completely fabricated.

Support structure for a 3D object is often utilized when fabricating 3D objects using an FDM or SLA system. However, in certain situations, support structure may be utilized when fabricating 3D objects using other types of AM systems. The support structure for a 3D object is wasted material, which is discarded after it is removed from the fabricated 3D object. In many cases, it cannot be reused, at least not directly, in the formation of another object, and is discarded. In some AM systems, fabricating the support structure undesirably adds to the total fabrication time of the 3D object. In addition, if the support structures are too tall and/or thin, the stability of the 3D object during fabrication may be compromised, resulting in a lower-quality or unacceptable object. All of these factors can undesirably increase the cost of the 3D object.

Referring now to the drawings, there is illustrated an example of an additive manufacturing system which provides a topographic build plate having plural blocks. Each block forms an “element” of the build plate. At least a portion of a support structure for the 3D object being fabricated is replaced by offsetting at least one of the topographic build plate blocks relative to at least one other of the blocks.

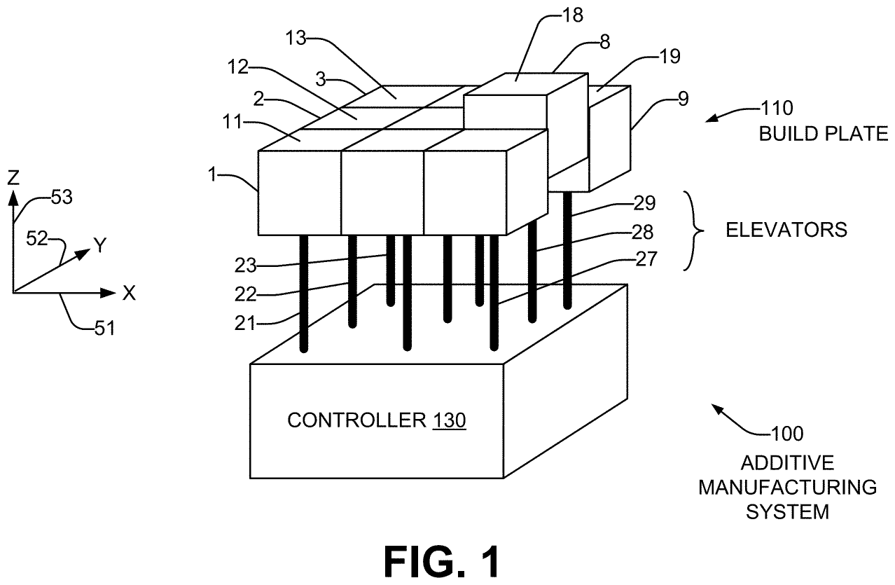

Considering now an additive manufacturing system, and with reference to FIG. 1, an additive manufacturing system 100 includes a topographic build plate 110. The topographic build plate 110 supports a 3D object which is fabricated layer-by-layer on the build plate 110. In many examples, the object is fabricated, beginning with a bottom layer of the object, on top of the build plate 110, while in some other examples the object is fabricated, beginning with a top layer of the object, below the build plate 110.

The build plate divided into plural elements, such as for example plural blocks 1-9. Each block 1-9 has a corresponding build surface 11-19 which is substantially planar and disposed substantially in an X-Y plane. Each block also has substantially planar side surfaces (walls) which extend substantially in a Z direction 53. The blocks are arranged adjacent each other in a non-overlapping pattern, which in some examples is a repeatable pattern. The build surfaces 11-19 may have any shape (including e.g. triangular, square, rectangular, or hexagonal) that allows the blocks to be arranged in this pattern. In some examples, the plural blocks 1-9 are rectangular and arranged in a grid pattern, where all the rectangular blocks 1-9 have the same dimension in the X direction 51 and the same dimension in the Y direction 52 orthogonal to the X direction 51. Each build surface 11-19 lies in an X-Y plane. The build surfaces 11-19 of all the blocks 1-9 are all on a same side of the blocks 1-9 (in this example, a top surface). The build surface of all blocks may be the same size, or one build surface may have a different size than another build surface.

In one example, each build surface 11-19 is between 1 and 5 centimeters in the X direction 51 and in the Y direction 52. In one example, the build plate 110 is between 5 centimeters and 50 centimeters in the X direction 51, and in the Y direction 52. In various examples, the blocks 1-9 may be metal, ceramic, glass, and/or another material. In various examples, the blocks 1-9 may be solid or hollow. In various examples, the build surface 11-19 (and/or other surfaces of the blocks 1-9) may have a coating which resists adherence by the unfused build material and/or the fused build material. As shown in FIG. 1 for clarity of illustration, build plate 110 has nine blocks 1-9. However, other example build plates may include a larger number of blocks in conformance with the range of build plate sizes and block dimensions indicated here.

The additive manufacturing system 100 includes elevators 21-29. Each individual one of the elevators 21-29 is coupled to a corresponding one of the blocks 1-9. An elevator 21-29 changes the location in the Z direction 53 (orthogonal to the X 51 and Y 52 directions) of its corresponding block 1-9. The build plate 110 is topographic in that each block 1-9 can be independently set to a different position along the Z axis from other blocks 1-9; in other words, a block 1-9 can be offset in the Z direction 53 from another block 1-9. However, in many examples, each block has a fixed X-Y position in the build plate 110.

In some examples, each elevator 21-29 may be implemented by mechanical, electrical, electro-mechanical, and/or pneumatic means. An elevator 21-29 may be a linear actuator that generates motion in a straight line under control of a rotating motor, for example, or operation of a piston. Each elevator 21-29 is sized to allow a desired maximum amount of Z direction 53 movement in its corresponding block 1-9.

The additive manufacturing system 100 also includes a controller 130. The controller 130 is coupled to the elevators 21-29 to selectively offset at least one of the blocks 1-9 from at least one other of the blocks 1-9 in the Z direction 53. In some examples, the offsetting operation is performed in-between fabrication of layers of the object. The controller 130 offsets at least one first block 1-9 from at least one second block 1-9 so as to position the build surfaces of the first and second blocks at different locations in the Z direction 53. This also positions the first block in a different, parallel X-Y plane from the second block. The offsetting operation may be performed by moving the first block, the second block, or both the first and second blocks. Where the first block corresponds to a position on the build plate 110 of a support structure for an overhang of the 3D object being fabricated, the offset between the first and second blocks allows the first block to replace at least a portion of the support structure, thus advantageously reducing the amount of build material used during fabrication, reducing the fabrication time, providing improved support for the overhang, and/or reducing the cost of the fabricated 3D object.

In many examples, the controller 130 also collectively moves all the blocks of the build plate in the Z direction 53 by a given amount in-between fabrication of each layer. In the illustrated example, where the build surface is on a top side of blocks 1-9, the movement is in the minus-Z direction (i.e. downward). The given amount of movement corresponds to the thickness of a layer the object. By doing this, the controller 130 positions the build plate 110 to receive the next layer of the object being fabricated, and allows each layer to be fabricated at the same location in the Z direction 53. This may simplify the AM system 100 by allowing components of a build engine of the AM system 100 (e.g. a build material source/dispenser/spreader, an extruder, a laser/laser-focusing mechanism, a printing and fusing mechanism, and/or other elements) to remain in the same location in the Z direction 53 for the fabrication of each layer.

In some examples, the collective movement of the blocks to accommodate the next layer may be in the opposite Z direction from that in which the first block is moved to offset it further from the second block.

In some examples, offsetting of the first block and movement of the build plate to accommodate the next layer may be performed in a combined operation. In such an example, the Z direction 53 location of the first block(s) is maintained, while the remaining (second) block(s) are collectively moved by the thickness of a layer. This has the effect of both increasing the offset between the first and second blocks by the thickness of a layer, and making room to receive the build material for the next layer.

In some examples, the build plate 110 may include some blocks which are not offsettable. For example, one or more border blocks at or near the edges of the build plate 100 may not be offsettable. Such border blocks may have a different size or form factor that blocks 1-9, such as for example a single frame around blocks 1-9.

In some examples, at least some of the blocks 1-9 are thermally conductive. When a thermally-conductive block is used to replace support structure and offset relative to the remainder of the build plate 110, that block is positioned closer in the Z direction 53 to the overhang of the 3D object than the remainder of the build plate 110. Certain AM technologies can generate a significant amount of heat during fabrication of a 3D object, and the proximity of the offset block to the overhang can more readily conduct heat away from the overhang. In addition, where the offset block is in thermal contact with other non-offset blocks of the build plate 110, heat can be transferred from the offset block to the other non-offset blocks, which may be cooler. By conducting heat away from the 3D object more effectively, the 3D object can be cooled down more quickly after fabrication.

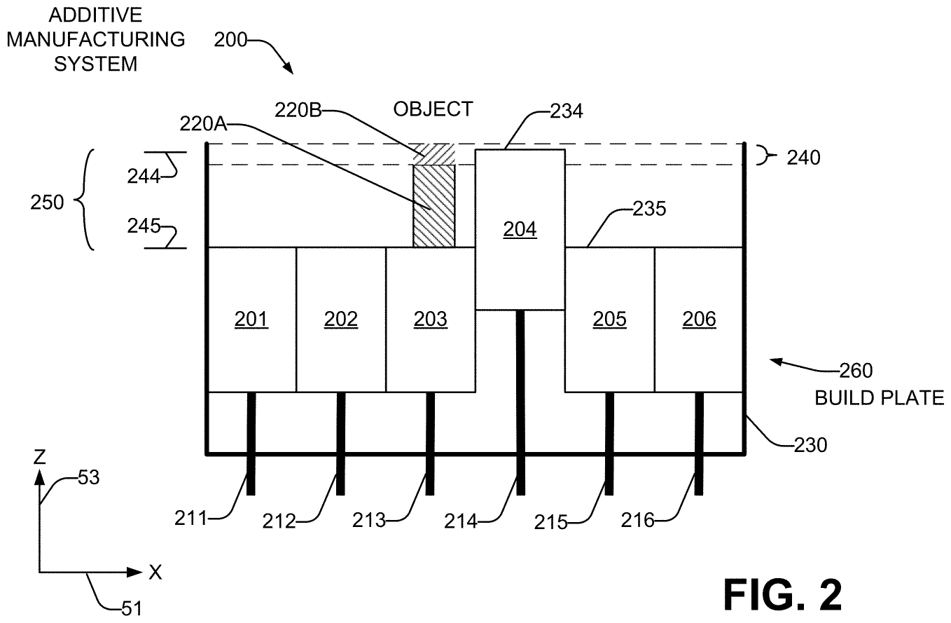

Considering now another additive manufacturing system, and with reference to the schematic side view of FIG. 2, an additive manufacturing system 200 has a build plate 260 having six blocks 201-206 in the X direction 51, each connected to a corresponding elevator 211-216. The blocks 201-206 are disposed in a build bed 230. In some examples, the build bed 230 may be up to 50 centimeters deep in the Z direction 53.

A 3D object 220 (having portions 220A-220B) is illustrated in the process of fabrication by the system 200. Portion 220A represents layers of the object 220 which have been previously fabricated, and portion 220B represents the layer of the object 200 that is presently being fabricated. In one example, the AM system 200 is of a type, such as FDM, which deposits at desired locations of the layer build material of a particular thickness 240 which corresponds to the thickness of the object portion 220B which is to be formed for that layer. The build material then solidifies and adheres to any previously-fabricated layers, such as those of the object portion 220A. In another example, the AM system 200 is of a type, such as an SLA system, which provides a layer 240 of build material (e.g. resin) having a thickness which corresponds to the thickness of the object portion 220B to be formed and selectively fuses the build material of the layer 240 at the location of the portion 220B, in order to form the portion 220B and adhere it to the portion 220A. Note that the thickness of the layer 240 is not drawn to scale, but is exaggerated for clarity of illustration of the concept of operation of the system 200.

The computer model for the object 220 also defines an overhang, which has not yet been fabricated in the stage of the process illustrated in FIG. 2. The overhang, when it is fabricated from subsequent layers 240 of build material, will extend above and over block 204. The computer model includes a support structure for a pillar that, using a non-topographic (flat) build plate, would be fabricated between block 204 and a bottom portion of the overhang. However, with the topographic build plate, at least a portion of the support structure pillar is replaced by the offset in the Z direction 53 of block 204 relative to the other blocks 201-203, 205-206.

In fabricating layer 240, block 204 continues to replace support structure for the object 220. As a result, the offset 250 between the plane 244 of the build surface of block 204 and the plane 245 of the build surfaces of blocks 201-203, 205-206 was increased before fabrication of the layer 240 and after fabrication of the prior layer. In addition, blocks 201-203, 205-206 were moved downward (in the minus-Z direction 53) by the thickness of layer 240, in order to allow layer 240 to be fabricated at the top of the build bed 230. In some examples, the build surface 234 of block 204 is positioned at the top of the layer 240. In other examples, the build surface 234 of block 204 is positioned somewhat lower, which may be done in order to avoid collisions between the block 204 and components of the build engine. As such, in some examples where a layer of build material is deposited, some of the build material is disposed over the build surface 234. In other examples, build material is not disposed over the build surface 234.

In some examples, the blocks 201-206 are constructed with sufficient top (build surface) and side surface flatnesses, and fitted in the system 200 adjacent each other with sufficient precision, to inhibit build material from entering between two blocks. Sufficient flatness and precision may be defined with reference to characteristics of the build material. In addition, the blocks 201-206 have a sufficient size in the Z direction 53 to accommodate a maximum desired offset distance in the Z direction 53.

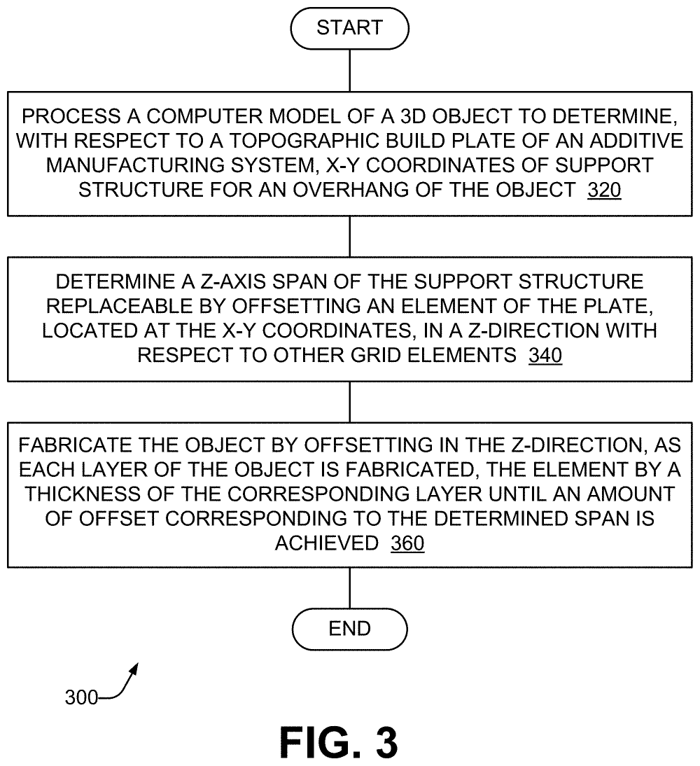

Consider now, with reference to FIG. 3, a method 300 of fabricating a 3D object using an additive manufacturing system, such as for example the AM system 100 (FIG. 1), 200 (FIG. 2). Alternatively, FIG. 3 may be considered as a flowchart of at least a portion of a method 300 implemented in the controller 130 (FIG. 1) or a controller (not shown) of the AM system 200 (FIG. 2).

At 320, a computer model of the 3D object is processed to determine, with respect to a topographic build plate, X-Y coordinates of support structure for an overhang of the object. At 340, a Z-axis span of the support structure replaceable by offsetting an element of the plate, located at the X-Y coordinates, in a Z-direction with respect to other grid elements is determined. At 360, the object is fabricated, the fabrication including offsetting in the Z-direction, as each layer of the object is fabricated, the grid element by a thickness of the corresponding layer until an amount of offset corresponding to the determined span is achieved.

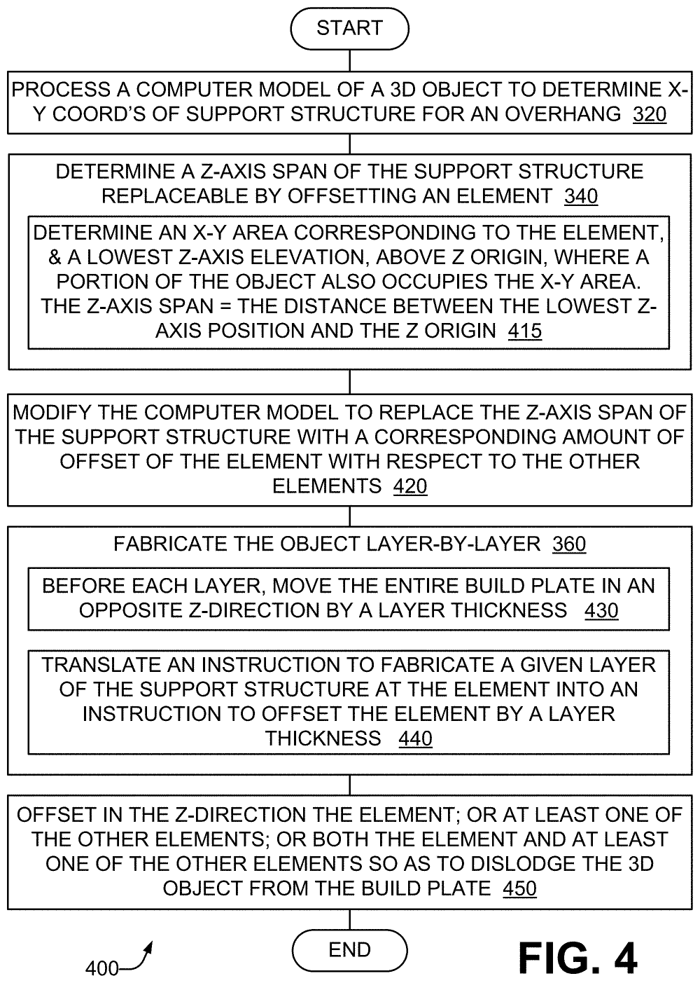

Consider now, with reference to FIG. 4, a method 400 of fabricating a 3D object using an additive manufacturing system, such as for example the AM system 100 (FIG. 1), 200 (FIG. 2). Alternatively, FIG. 4 may be considered as a flowchart of at least a portion of a method 400 implemented in the controller 130 (FIG. 1) or a controller (not shown) of the AM system 200 (FIG. 2). The method 400 includes blocks 320, 340, 360 (FIG. 3).

Block 340 (determining the Z-axis span of the support structure replaceable by offsetting an element) includes in some examples, at 415, determining an X-Y area corresponding to the grid element, determining a lowest Z-axis elevation, above Z origin, where a portion of the object also occupies the X-Y area, and identifying the Z-axis span as the distance between the lowest Z-axis position and the Z origin.

Block 360 (fabricating the object layer-by-layer) includes in some examples, at 430, moving all the grid elements of the build plate by the thickness of a layer in-between fabrication of two layers, or before fabrication of a new layer. In some examples, the grid element which replaces the support structure moves in one Z-direction along the Z-axis, while the entire build plate is moved in the opposite Z-direction.

Block 360 also includes in some examples, at 440, translating an instruction to fabricate a given layer of the support structure at the grid element into a corresponding instruction to offset the grid element by the thickness of the layer. In this case, the computer model for the 3D object is not modified. In other examples, at block 420, the computer model is modified to replace the span of the support structure with a corresponding amount of offset of the grid element with respect to the other grid elements. The 3D object is then fabricated at 360 according to the modified computer model.

In some examples, at 450, after all the layers of the 3D object have been fabricated, selected grid elements are moved along the Z-axis to dislodge the 3D object from the build plate and facilitate its removal from the build bed. The selected grid element(s) may be the offset grid element; at least one of the other grid elements; or both the offset grid element and at least one of the other grid elements.

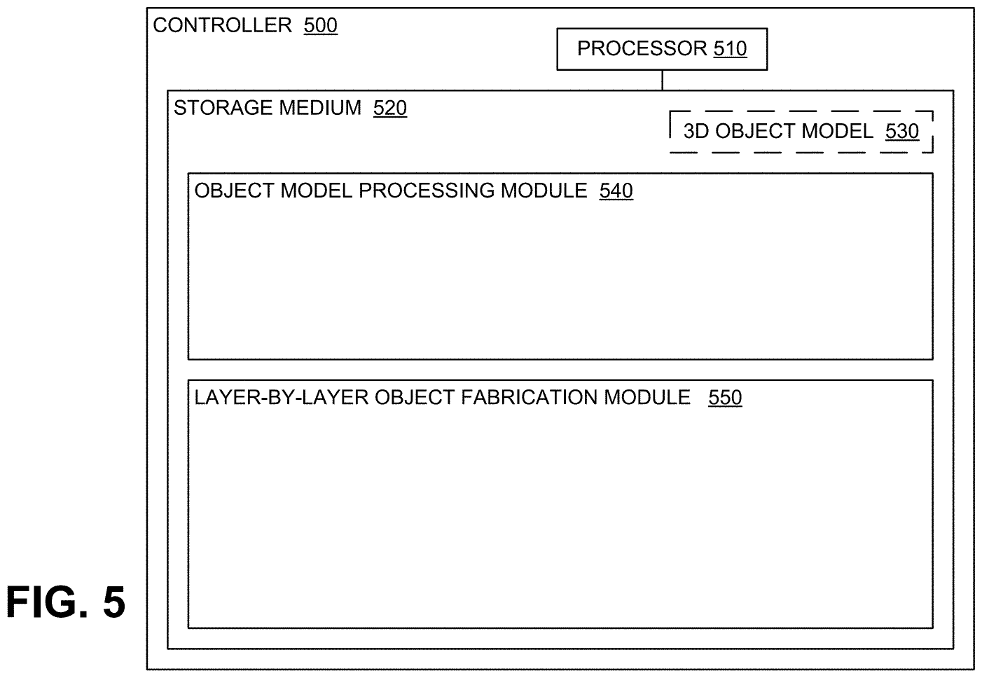

Considering now one example controller of an additive manufacturing system, and with reference to FIG. 5, a controller 500 includes a processor 510 coupled to a non-transitory computer-readable storage medium 520 which has stored program instructions executable by the processor 510. The program instructions include an object processing module 540 and a layer-by-layer object fabrication module 550. Data for a 3D object model 530 for the 3D object to be fabricated may also be included in the storage medium 520.

The object processing module 540 includes instructions to process the computer model 530 of a 3D object in order to map a support structure for an overhang of the object to an element at X-Y coordinates of a topographic build plate. The module 540 also determines a Z-axis span of the support structure that is replaceable by offsetting the grid element in a Z-direction with respect to other grid elements. In some examples, the object processing module 540 modifies the computer model 530 to replace the Z-axis span of the support structure with a corresponding Z-axis offset of the grid element relative to other grid elements of the plate.

The layer-by-layer object fabrication module 550 includes instructions to control elevators for the grid elements during object fabrication. Before fabricating each layer of the object, the module 550 controls an elevator for the grid element to offset the grid element further away from the other grid elements along the Z-axis by a distance of a layer thickness until an amount of offset corresponding to the determined span is achieved. In some examples, before fabricating each layer of the object, the module 550 controls elevators for all the grid elements to move the entire build plate the distance of a layer thickness along the Z-axis.

In some examples, the computer readable storage medium 520 includes different forms of memory including semiconductor memory devices such as DRAM, or SRAM, Erasable and Programmable Read-Only Memories (EPROMs), Electrically Erasable and Programmable Read-Only Memories (EEPROMs) and flash memories; magnetic disks such as fixed, floppy and removable disks; other magnetic media including tape; and optical media such as Compact Disks (CDs) or Digital Versatile Disks (DVDs). The instructions of the programs and modules discussed above can be provided on one computer-readable or computer-usable storage medium, or alternatively, can be provided on multiple computer-readable or computer-usable storage media distributed in a large system having possibly plural nodes. Such computer-readable or computer-usable storage medium or media is (are) considered to be part of an article (or article of manufacture). An article or article of manufacture can refer to any manufactured single component or multiple components.

In some examples, at least one block discussed herein is automated. In other words, apparatus, systems, and methods occur automatically. As defined herein and in the appended claims, the terms “automated” or “automatically” (and like variations thereof) shall be broadly understood to mean controlled operation of an apparatus, system, and/or process using computers and/or mechanical/electrical devices without the necessity of human intervention, observation, effort and/or decision.

Considering now an example 3D object to be fabricated by the AM system 100 (FIG. 1), 200 (FIG. 2), a computer model 600 describes a 3D object 610. In one example, the computer model 600 describes the geometry of the object 610 in accordance with the Standard for the Exchange of Product model data (“STEP”) and/or with ISO 10303. The computer model 600 may alternatively describe the object 610 according to a different standard.

The 3D object has a base portion 612 and an overhanging portion 614. An AM system, such as for example the system 100 (FIG. 1), 200 (FIG. 2), fabricates the 3D object 610 according to the model 600. Assume, in this example, that the object 610 is to be fabricated layer-by-layer, beginning with the bottom layer, on a top surface of a build plate 620, and that the object 610 is to be fabricated in the illustrated orientation with reference to the build plate 620. As such, during fabrication of the 3D object 610 the base 612 will be in contact with the top surface of the build plate 620, but the overhang 614 will not be in contact with the top surface of the build plate 620. In some cases, the mass and center of gravity of the overhang 614, relative to the base 612, could cause the object 610 to move during fabrication causing misalignment of adjacent layers, and/or the overhang 614 could break off from the base 612. In order to avoid these undesirable effects, and to support the overhang 614 during fabrication, the model 600 also includes sacrificial support structures 616 which during fabrication extend from a bottom surface of the overhand 614 to the top surface of the build plate 620. After fabrication of the object 610 is complete, the support structures 616 can be removed from the object 610, and discarded as waste material.

The model 600 assumes that the entire surface of the build plate 620 is in substantially the same X-Y plane; in other words, the model is unaware of a build plate 620 having topographic capability. Assume, for purposes of illustration, that the bottom layer of the base 612 and of the support structures 616 will be disposed during fabrication on the grid elements 622-628 of the topographic build plate 620 as indicated by the arrows.

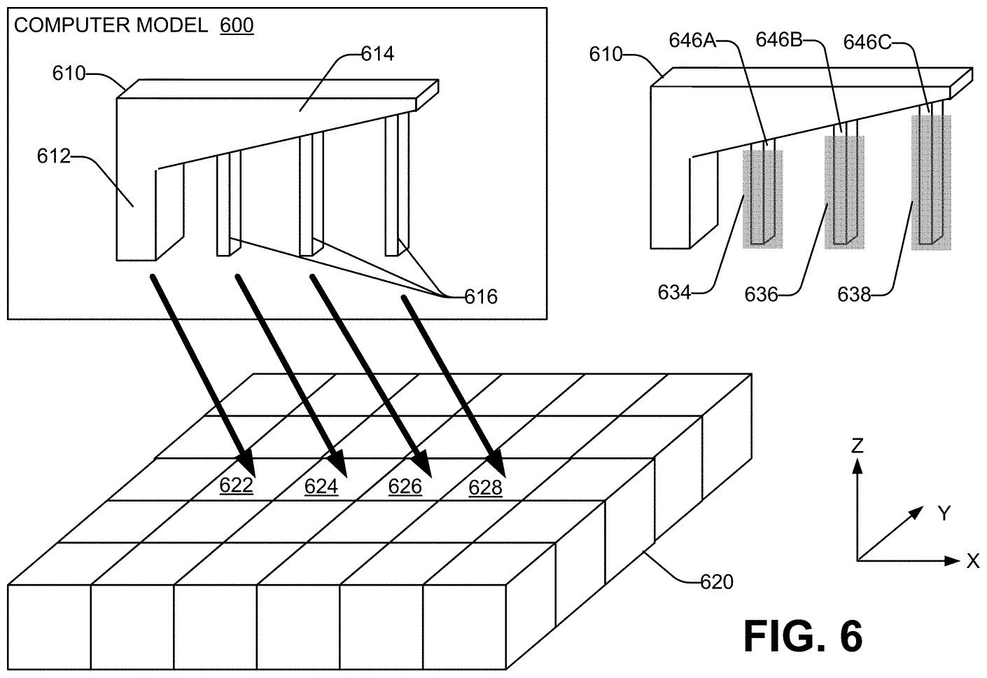

By utilizing the topographic build plate, a Z-axis span of each support structure 616 can be replaced during fabrication of the object by a selective offset of the grid elements 624, 626, 628 from the grid element 622 and/or from other grid elements of the build plate 620. The offset of grid element 624 replaces a first Z-axis span 634; the offset of grid element 626 replaces a second Z-axis span 636; and the offset of grid element 628 replaces a Z-axis span 638. Each Z-axis span 634-638 (which are illustrated in FIG. 6 by shading) is of a different distance in the case of the example object 610. Instead of the longer support structures 616, the object 610 is fabricated using shorter support structures 646A, 646B, 646C (collectively support structures 646). In some examples, the span in the Z-direction of the shorter support structures 646 depends on the geometry of the object 610, as discussed subsequently in greater detail with regard to an example fabrication process of an example 3D object.

While the example 3D object 610 illustrated in FIG. 6 is simplified for clarity of illustration, the present disclosure is applicable to the fabrication of much more complex 3D objects.

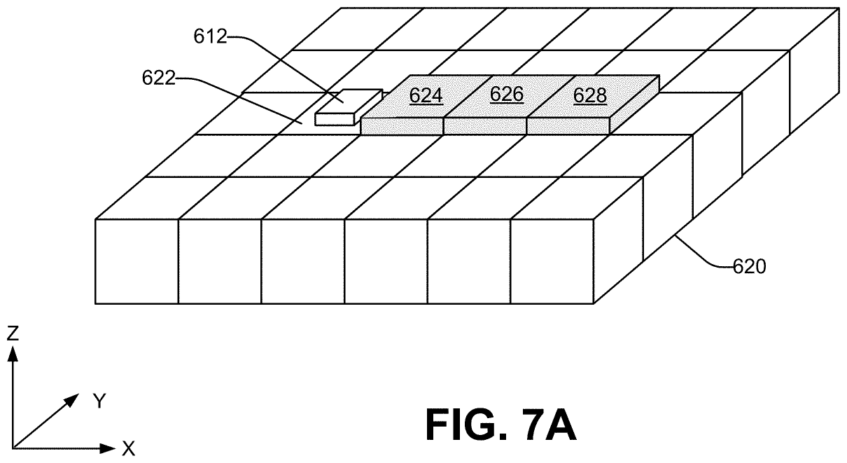

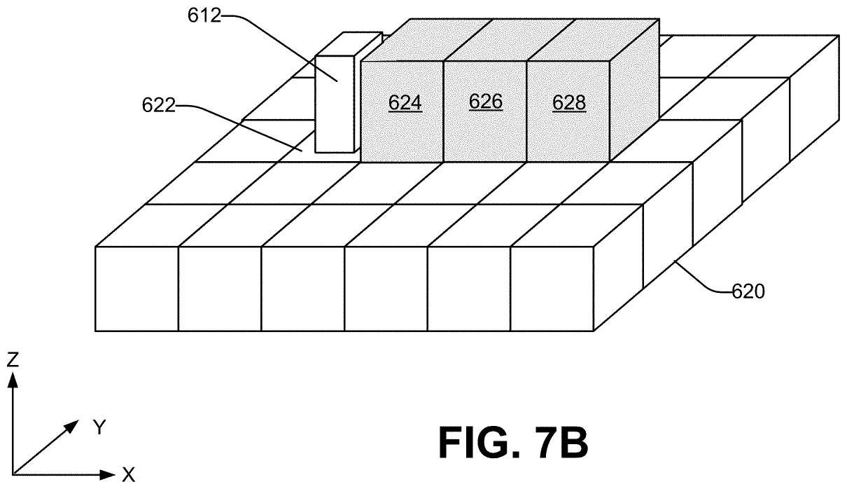

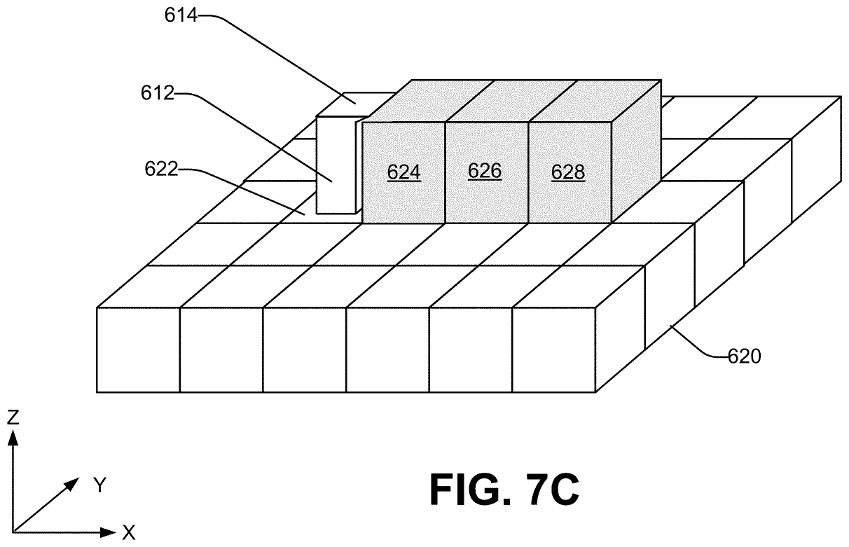

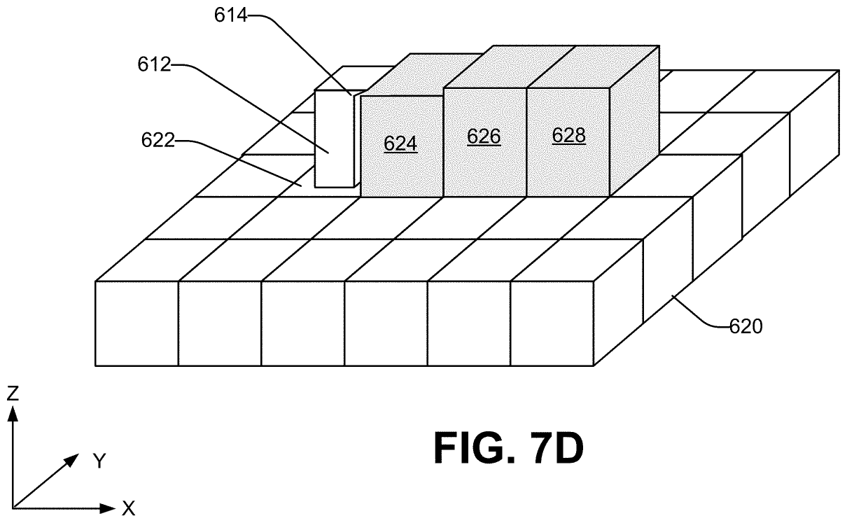

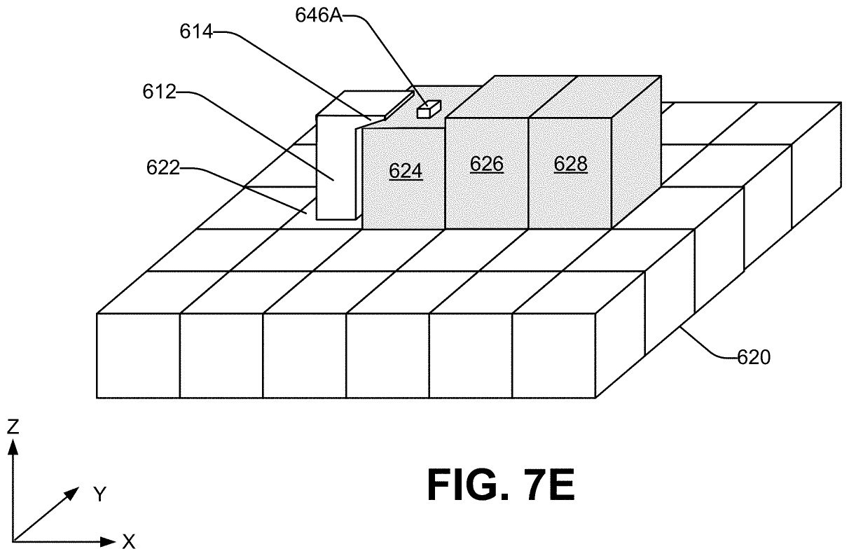

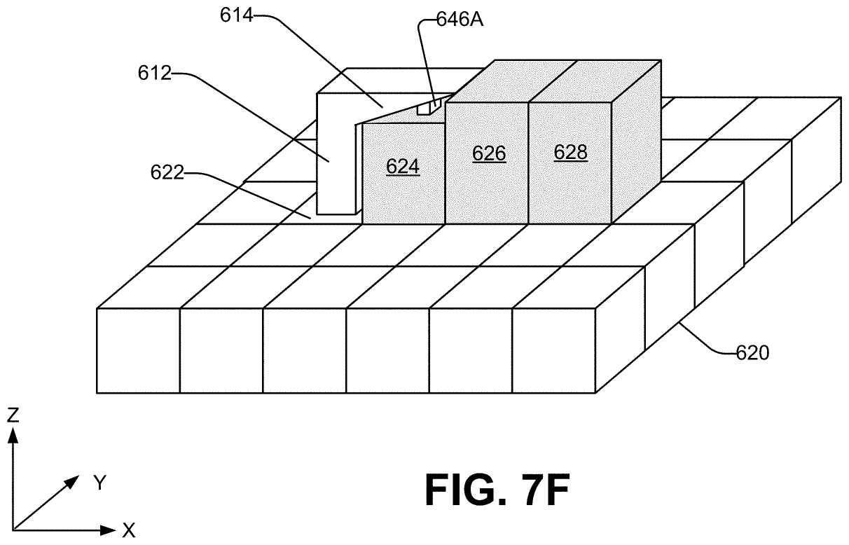

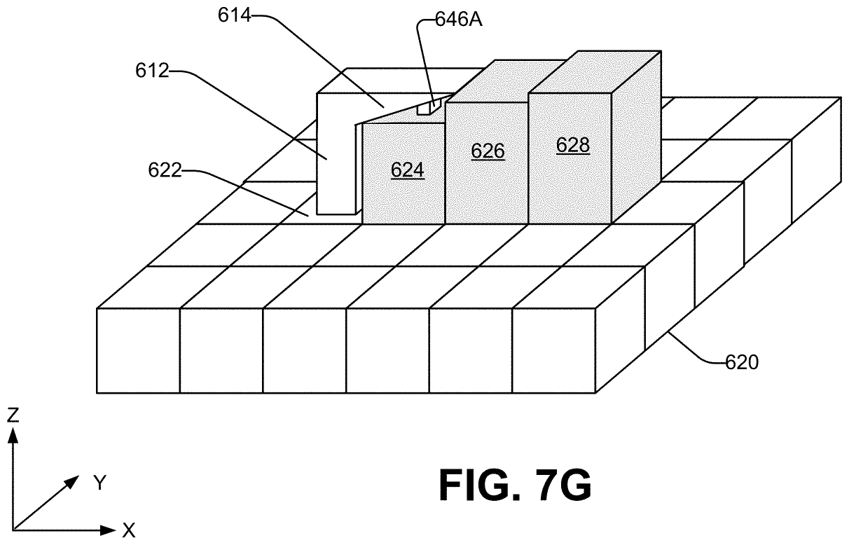

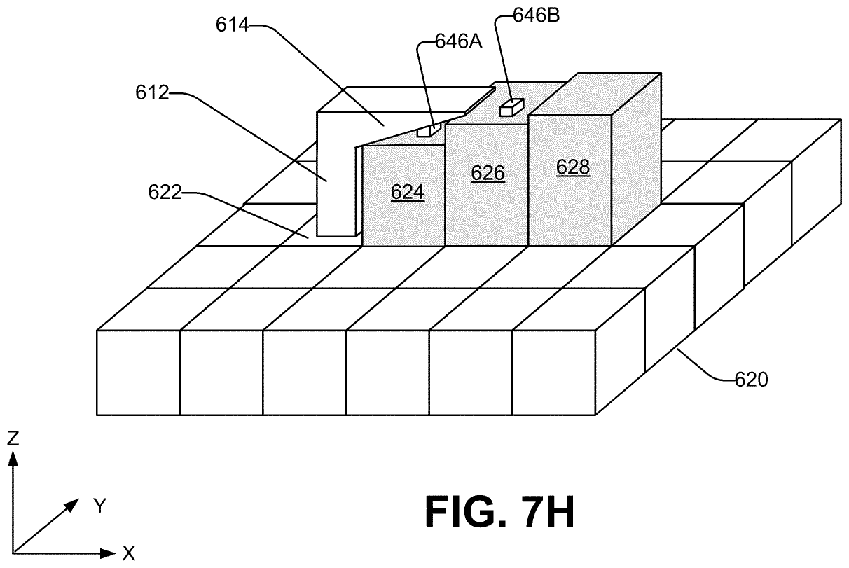

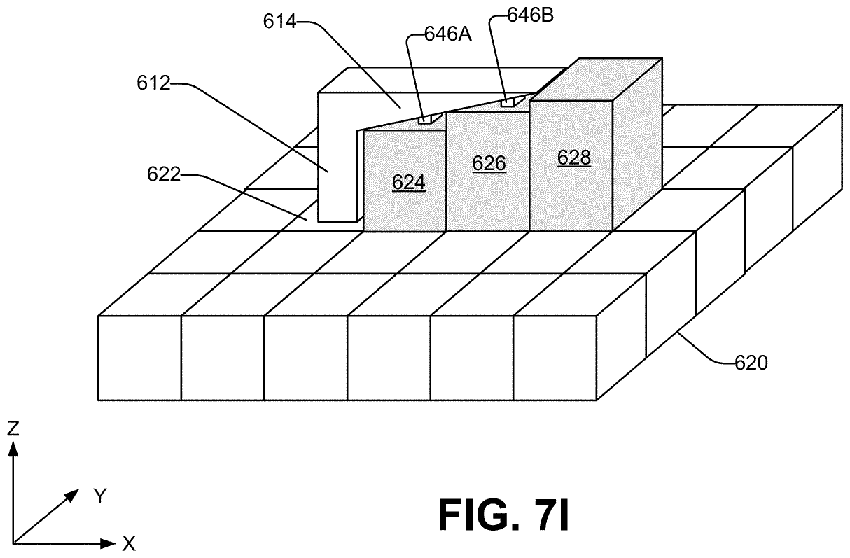

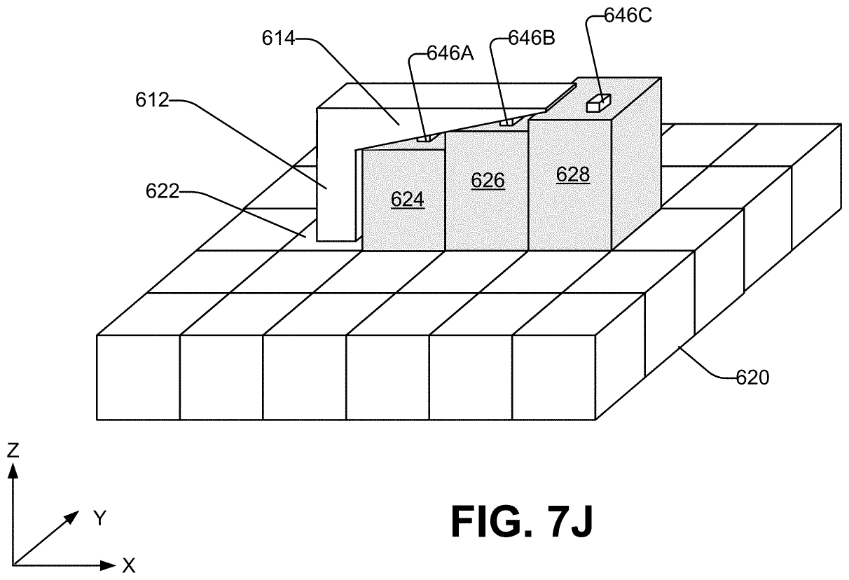

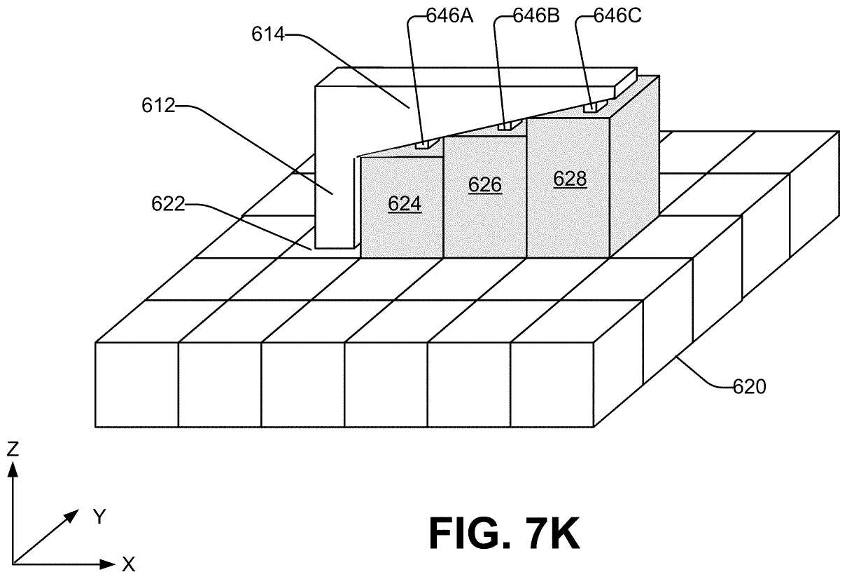

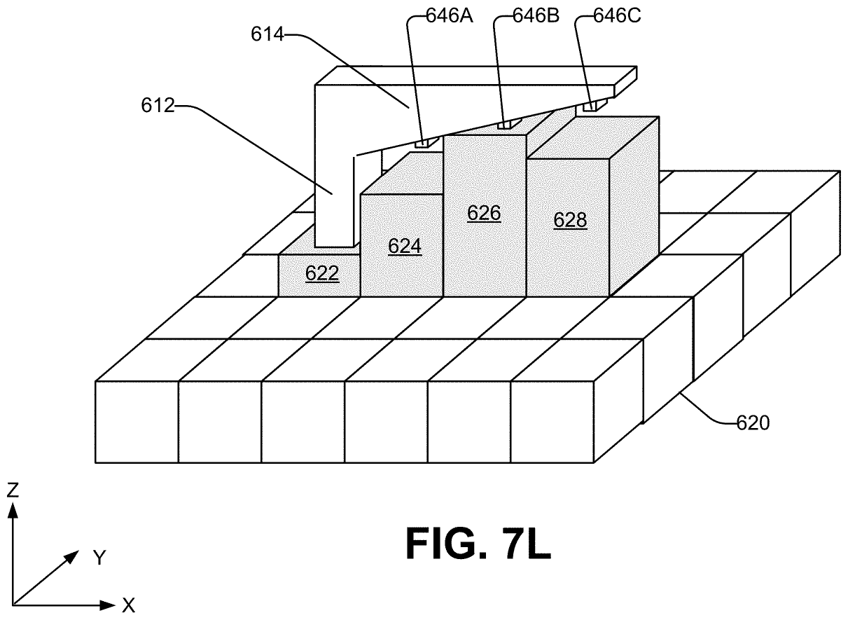

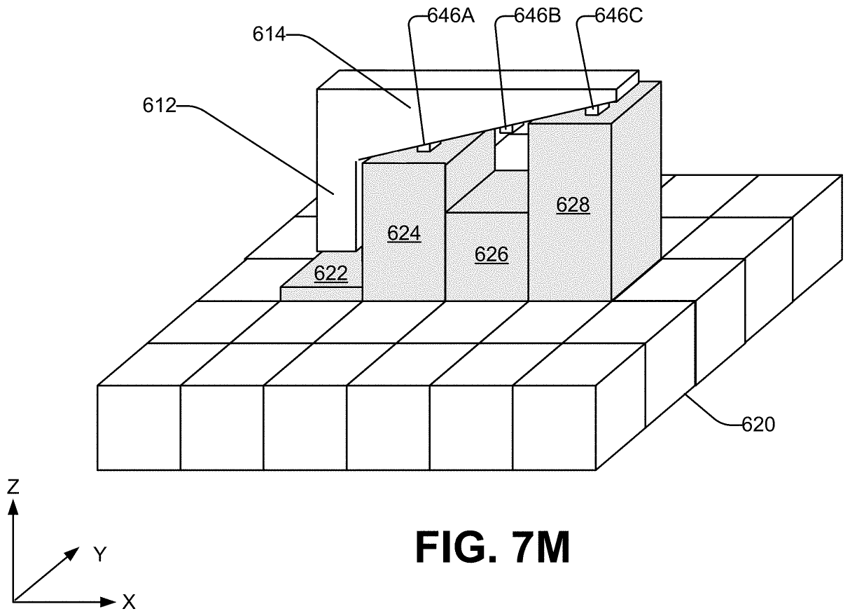

Considering now the fabrication of an example 3D object using a topographic build plate, and with further reference to FIGS. 7A through 7M, the fabrication of the 3D object 610 using the topographic build plate 620 is described and illustrated at various stages of fabrication. During fabrication, certain grid elements of the build plate 620 are offset on a layer-by-layer basis from other grid elements to replace a Z-axis span of support structures 616 for the object 610, resulting in the object 610 being fabricated with shorter support structures 646. As discussed heretofore, the build plate 620 as a whole may be moved downward in the Z direction by the thickness of a layer after a layer has been fabricated, while the grid elements which are offset may be moved upward in the Z direction to increase the amount of offset by the thickness of a layer.

Note that, for clarity of illustration, the full span of the individual grid elements in the Z direction may not be shown. Also, for clarity of illustration, the grid elements which are offset from other elements are shaded, while the object 610 is shown without shading.

After a first stage of fabrication, and with reference to FIG. 7A, lower layers of the base 612 have been fabricated on the build surface of grid element 622. Grid elements 624, 626, 628 will replace support structure, and thus have been offset from the other grid elements of the build plate 620.

After a second stage of fabrication, and with reference to FIG. 7B, additional layers of the base 612 have been fabricated on the build surface of grid element 622, and grid elements 624, 626, 628 have been further offset from the other grid elements of the build plate 620 by an amount which corresponds to the additional base layers.

After a third stage of fabrication, and with reference to FIGS. 7C-7D, the base 612 has been completed, and the lower layers of the overhang 614 have been fabricated, as illustrated in FIG. 7C. As a result, the overhang 614 has started to extend from grid element 622 towards grid element 624, and has reached grid element 624. From the beginning of fabrication through the third stage, the grid elements 624, 626, 628 have been further offset from the other grid elements of the build plate 620 each time a new layer is fabricated. But in the next layer to be fabricated, a portion of the overhang 614 will now extend over the build surface of grid element 624. As a result, before this next layer is fabricated, grid elements 626 and 628 are further offset from the other grid elements of the build plate 620 by the thickness of a layer, but grid element 624 is not, as illustrated in FIG. 7D. No further offset will be applied to grid element 624 until after fabrication of the object 610 is complete. Grid element 624 will continue to move downward with the downward movement of the build plate 620, but the offset will remain the same. Because no further offset of grid element 624 is performed, fabrication of the support structure 646A will begin.

After a fourth stage of fabrication, and with reference to FIG. 7E, the overhang now extends over grid element 624, and the lower layers of the support structure 646A have been fabricated in addition. Grid elements 626, 628 have been further offset, on a layer-by-layer basis, from the other grid elements of the build plate 620 by an amount which corresponds to the additional layers of the overhang 614 and the support structure 646A.

After a fifth stage of fabrication, and with reference to FIGS. 7F-7G, the overhang 614 has extended all the way over and across grid element 624, and has reached grid element 626, as illustrated in FIG. 7F. From the beginning of fabrication through the fifth stage, the grid elements 626, 628 have been further offset from the other grid elements of the build plate 620 each time a new layer is fabricated. But in the next layer to be fabricated, a portion of the overhang 614 will now extend over the build surface of grid element 626. As a result, before this next layer is fabricated, grid element 628 is further offset from the other grid elements of the build plate 620 by the thickness of a layer, but grid element 626 is not, as illustrated in FIG. 7G. No further offset will be applied to grid element 626 until after fabrication of the object 610 is complete. Grid element 626 will continue to move downward with the downward movement of the build plate 620, but the offset will remain the same. Because no further offset of grid element 626 is performed, fabrication of the support structure 646B will begin.

After a sixth stage of fabrication, and with reference to FIG. 7H, the overhang now extends over grid element 626, the support structure 646A has been completely fabricated, and the lower layers of the support structure 646B have been fabricated in addition. Grid element 628 has been further offset, on a layer-by-layer basis, from the other grid elements of the build plate 620 by an amount which corresponds to the additional layers of the overhang 614 and the support structure 646B.

After a seventh stage of fabrication, and with reference to FIG. 7I, the overhang 614 has extended all the way over and across grid element 626, and has reached grid element 628. From the beginning of fabrication through the seventh stage, the grid element 628 has been further offset from the other grid elements of the build plate 620 each time a new layer is fabricated. But in the next layer to be fabricated, a portion of the overhang 614 will now extend over the build surface of grid element 628. As a result, no further offset will be applied to grid element 628 until after fabrication of the object 610 is complete. Grid element 628 will continue to move downward with the downward movement of the build plate 620, but the offset will remain the same. Because no further offset of grid element 624 is performed, fabrication of the support structure 646C will begin.

After an eighth stage of fabrication, and with reference to FIG. 7J, the overhang now extends over grid element 628, the support structure 646B has been completely fabricated, and the lower layers of the support structure 646C have been fabricated in addition.

After a ninth stage of fabrication, and with reference to FIG. 7K, fabrication of the object 310 is complete.

In some examples, and with reference to FIGS. 7L-7M, offsetting certain grid elements can dislodge the object 610 from the build surfaces of the grid elements of the build plate 620, and facilitate removal of the object 610 from the build bed. The grid elements for which the offset is changed may be determined by the geometry of the object 610 or in another manner. For the object 610, as illustrated in FIG. 7L, grid elements 622, 626 are offset by an additional distance in the Z direction. Doing so dislodges support structures 646A, 646C from the build surface of grid elements 624, 628 respectively. Next, as illustrated in FIG. 7M, grid elements 624, 628 are offset by an additional distance in the Z direction such that their build surfaces contact supports structures 646A, 646C, and then grid elements 622, 626 are lowered to dislodge the base 612 and support structure 646B from the build surface of grid elements 622, 626 respectively. After this, the object 610 can be more easily removed from the build bed. Note that the amount of the changes in offset illustrated in FIGS. 7L-7M may be exaggerated to clearly illustrate the operation, and may be much smaller in practice.

While grid elements outside the footprint of the object 610 (such as those along the edges of the build plate 620) receive no offset in the example fabrication process illustrated in FIGS. 7A-7M, in other examples these grid elements could also be offset on a layer-by-layer basis if it is advantageous to do so in a particular AM system.

From the foregoing it will be appreciated that the AM systems, methods, and storage medium provided by the present disclosure represent a significant advance in the art. Although several specific examples have been described and illustrated, the disclosure is not limited to the specific methods, forms, or arrangements of parts so described and illustrated. This description should be understood to include all combinations of elements described herein, and claims may be presented in this or a later application to any combination of these elements. The foregoing examples are illustrative, and different features or elements may be included in various combinations that may be claimed in this or a later application. Terms of orientation and relative position (such as “top,” “bottom,” “side,” and the like) are not intended to indicate a particular orientation of any element or assembly, and are used for convenience of illustration and description. Unless otherwise specified, operations of a method claim need not be performed in the order specified. Similarly, blocks in diagrams or numbers (such as (1), (2), etc.) should not be construed as operations that proceed in a particular order. Additional blocks/operations may be added, some blocks/operations removed, or the order of the blocks/operations altered and still be within the scope of the disclosed examples. Further, methods or operations discussed within different figures can be added to or exchanged with methods or operations in other figures. Further yet, specific numerical data values (such as specific quantities, numbers, categories, etc.) or other specific information should be interpreted as illustrative for discussing the examples. Such specific information is not provided to limit examples. The disclosure is not limited to the above-described implementations, but instead is defined by the appended claims in light of their full scope of equivalents. Where the claims recite “a” or “a first” element of the equivalent thereof, such claims should be understood to include incorporation of at least one such element, neither requiring nor excluding two or more such elements. Where the claims recite “having”, the term should be understood to mean “comprising”.

What is claimed is:

1. An additive manufacturing system, comprising:
a topographic build plate to support a 3D object fabricated layer-by-layer, the build plate divided into plural blocks each having a build surface;
plural elevators each coupled to a corresponding one of the blocks; and
a controller coupled to the elevators to offset in a Z-direction, in-between fabrication of layers of the object, a first one of the blocks from a second one of the blocks to position the build surfaces of the first and second blocks at different Z-direction locations to replace at least a portion of a support structure of the 3D object.

2. The additive manufacturing system of claim 1, wherein the blocks have a rectangular build surface and form a grid in the X-Y direction.

3. The additive manufacturing system of claim 2, wherein
each build surface is in an X-Y plane to which the Z-direction is orthogonal, and
the offset between the first and second blocks in the Z-direction positions the build surfaces of the first and second blocks in different, parallel X-Y planes.

4. The additive manufacturing system of claim 1, wherein
each block has a fixed X-Y position in the build plate, and
the build surface is on a same side of each of the blocks.

5. The additive manufacturing system of claim 1, wherein
a base portion of the 3D object is formed on the second block,
a remaining portion of the support structure for the overhang is formed on the first block, and
an overhang of the 3D object is formed above the first block.

6. The additive manufacturing system of claim 1, wherein
a 3D computer model describes the 3D object and the support structure,
the controller processes the 3D model to identify the first block as corresponding to the support structure, and
the controller determines a number of layers of a span of the support structure to be replaced by the offset of the first block.

7. The additive manufacturing system of claim 1, wherein
a layer of the 3D object has a thickness, and
a distance of the offset in the Z-direction corresponds to the thickness.

8. The additive manufacturing system of claim 1, wherein each build surface is between 1 and 5 centimeters in the X direction and in the Y direction, and wherein the build plate is between 5 centimeters and 50 centimeters in the X direction and in the Y direction.

9. A method of fabricating a 3D object using an additive manufacturing system, comprising:
processing a computer model of the object to determine, with respect to a topographic build plate, X-Y coordinates of support structure for an overhang of the object;
determining a Z-axis span of the support structure replaceable by offsetting an element of the plate, located at the X-Y coordinates, in a Z-direction with respect to other elements; and
fabricating the object by offsetting in the Z-direction, as each layer of the object is fabricated, the element by a thickness of the corresponding layer until an amount of offset corresponding to the determined span is achieved.

10. The method of claim 9, wherein the fabricating comprises:
translating an instruction to fabricate a given layer of the support structure at the element into an instruction to offset the element by the thickness of the layer.

11. The method of claim 9, comprising:
modifying the computer model to replace the span of the support structure with a corresponding amount of offset of the element with respect to the other elements; and
fabricating the 3D object according to the modified computer model.

12. The method of claim 9, comprising:
after all layers of the 3D object have been fabricated, further offsetting in the Z-direction the element, at least one of the other elements, or both the element and at least one of the other elements so as to dislodge the 3D object from the build plate.

13. A non-transitory computer-readable storage medium having an executable program stored thereon, wherein the program instructs a processor to:
process a computer model of a 3D object to map a support structure for an overhang of the object to an element at X-Y coordinates of a topographic build plate;
determine a Z-axis span of the support structure replaceable by offsetting the element in a Z-direction with respect to other elements; and
before fabricating each layer of the object, control an elevator to offset the element further away from the other elements along the Z-axis by a distance of a layer thickness until an amount of offset corresponding to the determined span is achieved.

14. The medium of claim 13, wherein the program instructs the processor to:
before fabricating each layer of the object, control elevators for all the elements to move the entire build plate the distance of a layer thickness along the Z-axis.

15. The medium of claim 13, wherein to determine the Z-axis span the program instructs the processor to:
determine an X-Y area corresponding to the element;
determine a lowest Z-axis elevation, above Z origin, where a portion of the object also occupies the X-Y area; and
identify the Z-axis span as the distance between the lowest Z-axis position and the Z origin.
